(19) United States
(12) Patent Application Publication
(10) Pub. No.: US 2009/0125498 A1
(43) Pub. Date: May 14, 2009

(54) Doubly Ranked Information Retrieval and Area Search

(75) Inventors: Yu Cao, Monterey Park, CA (US); Leonard Kleinrock, Los Angeles, CA (US)

Correspondence Address: FISH & ASSOCIATES, PC;ROBERT D. FISH, 2603 Main Street, Suite 1000, Irvine, CA, 92614-6232, US

(73) Assignee: THE REGENTS OF THE UNIVERSITY OF CALIFORNIA, Oakland, CA (US)

(21) Appl. No.: 11/916,871

(22) PCT Filed: Jun. 6, 2006
(86) PCT No.: PCT/US2006/022044

§ 371 Date: Jun. 18, 2008

Related U.S. Application Data
(60) Provisional application No. 60/688,987, filed on Jun. 8, 2005.

(51) Int. Cl. G06F 17/30

(52) U.S. Cl. 707/5; 707/3; 707/E17.008; 707/E17.014; 707/E17.017

(57) ABSTRACT

In a search system, document terms are weighted as a function of prevalence in a data set, the documents are scored as a function of prevalence and weight of the document terms contained therein, and then independently, the documents are ranked for a given search as a function of (a) their corresponding document scores and (b) the closeness of the search terms and the document terms. The steps can all be accomplished using matrices. Subsets of the documents can be identified with various collections, and each of the collections can be assigned a matrix signature. The signatures can then be compared against terms in the search query to determine which of the subsets would be most useful for a given search.

This application claims priority to U.S. provisional application Ser. No. 60/688,987, filed Jun. 8, 2005.

This invention was made with Government support under Grant Nos. DABT63-84-C-0080 and DABT63-84-C-0055 awarded by the DARPA. The Government has certain rights in this invention.

A portion of the material in this patent document is subject to copyright protection under the copyright laws of the United States and of other countries. The owner of the copyright rights has no objection to the facsimile reproduction by anyone of the patent document or the patent disclosure, as it appears in the United State Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

The provisional application, and all other materials cited herein, are incorporated by reference in their entirety.

### FIELD OF THE INVENTION

The field of the invention is electronic searching of information.

### BACKGROUND

Prior art Information Retrieval (IR) tools are relatively good at providing useful results to three classes of queries: (1) broad but “shallow” search; (2) “narrow and accurate” searches; and (3) searches for “what others are talking about”. They are not very good at responding to “topical searches”.

“Broad but shallow searches” typically return result sets with many matching pages, and ranking them is not terribly important. For example, with queries such as “travel” or “flowers”, a user usually is asking “where do I get travel information” or “where do I order flowers.” Many web pages are designed to be matched with such queries. Once these pages are returned by a Web search engine, the user reads these pages and his information need is satisfied.

With current Web search, matching is done by exact matching of words and proximity search. Since only words are known to Web search, typically the matching is so “exact” that not even stemming is used, e.g. “flowers” and “flower” return different results. Because the position of each word in the document is known, proximity search is also possible. (Proximity search assigns a score depending on order and distance of the matching between query words and document words.) Typically statistical information of words in documents is not used. Web search is not aware of phrases but only words, although phrases in a user query does match up with those in a document, but this is an artifact of exact matching and proximity search.

“Narrow and accurate” searches typically trigger result sets with relatively few pages. Queries with persons' names or product models' names usually are of this type of search. From the search engine's point of view, whether those pages containing the query words are in the database at all determines whether the information need can be satisfied. The main service the search engine provides therefore is being able to haul in as many pages on the Web possible. In Web search jargon, to perform well with such queries is to “do well at the tail”.

Searches for “what others are talking about” are poorly addressed by Web page searches, because the pages are usually replete with consumer product contains claims, boasts and blurbs, and almost never contain critical comments. So if one's search task is to find out what others are talking about the product, the page is not a good place to look. Nevertheless, Web search engines have a great potential of serving such search tasks very well, since they have access to a relatively complete collection of the entirety of the web by striving to crawl every (non-spam) Web page.

In conducting this type of search, the main approach by current Web search engines is to use the “anchor text”. Anchor text is the words or sentences surrounded by the HTML hyperlink tags, so it could be seen as annotations for the hyperlinked URL. By collecting all anchor text for a given URL, a Web search engine gets to know what other Web pages are “talking about” the given URL. For example, many web pages have the anchor text “search engine” for http://www.yahoo.com; therefore, given the query “search engine”, a search engine might well return http://www.yahoo.com as a top result, although the text on the Web page http://www.yahoo.com itself does not have the phrase “search engine” at all.

“Topical searching” is an area in which the current search engines do a very poor job. Topical searching involves collecting relevant documents on a given topic and finding out what this collection “is about” as a whole. When engaged in topical research, a user conducts a multi-cycled search: a query is formed and submitted to a search engine, the returned results are read, and “good” keywords and keyphrases are identified and used in the next cycle of search. Both relevant documents and keywords are accumulated until the information need is satisfied, concluding a topical research. The end product of a topical research is thus a (ranked) collection of documents as well as a list of “good” keywords and key phrases seen as relevant to the topic.

Prior art search engines are inadequate for topical searching for several reasons. First, there is the issue with respect to exact matching; it is sometimes difficult to formulate queries because the search engine considers only exact matches, or stemming matches. Second, the effectiveness of anchor texts is problematic in at least the following two ways: (a) hyperlinks are many times simply not created by the author who is writing about a particular Web site or Web page; (b) meaningless but often used “anchor text stop-words” such as “click here, more info” simply do not help. Third, in the prior art search engines the terms (keywords and keyphrases) are not scored. Search engines aim at getting documents; therefore, there is no need to score keywords and key phrases. However for topical research, the relative importance of individual keywords and phrases matters a great deal. Fourth, where link analysis is used, the documents' scores are derived from global link analysis, and are therefore not useful for most specific topics. For example, web sites of all “famous” Internet companies have high scores, however, a topical research on “Internet” typically is not interested in such web sites whose high scores get in the way of finding relevant documents.

The inadequacy of the current approaches with respect to topic searching cannot readily be remedied by cleverness on the part of the searcher. For example, consider the case of a researcher (user) seeking an overview of the journal IEEE Transactions on Software Engineering during a paper research. The user could start by submitting the query “+publication:‘IEEE Transactions on Software Engineering’” to http://portal.acm.org, the portal Web site of the ACM (Association of Computing Machinery), which will display in response that it has “found 2,028 of 863,039” citation records, and will display 200 of them, all of them coming from the journal.

The user's process of creating an overview of this journal can be outlined as:

reading citations, then identifying important terms (keywords and keyphrases);

identifying related citations via important terms;

further identifying citations believed to be important;

reading those citations and looping back to step 1 if not satisfied with the results;

recording important terms and citations.

The process is a “thorough” one but impractical because of the sheer number of citations and terms in a journal. Indeed, the process is even more time consuming an inefficient if the user makes use of other information in citations, e.g., references, authorship, etc.

Current search engines improve the efficiency of topical searches to some degree through the use of Ranked Information Retrieval (Ranked IR). In particular, they return matched documents that are ranked with the hope that the higher a document is ranked, the more relevant it is to the user's information need. Latent Semantic Indexing (LSI) provides one method of ranking, that uses a Singular Value Decomposition based approximate of a document-term matrix. (see S. Deerwester, S. T. Dumais, G. W. Furnas, T. K. Landauer and R. Harshman, “Indexing by Latent Semantic Analysis”, Journal of the American Society for Information Science 41(6) (1990), pp. 391-407). Once this is done, a query is compared to each document with this approximate matrix instead of the original one. LSI's authors explain the method's effectiveness with factor analysis, and other researchers have given explanations such as multiple regression model (see B. T. Bartell, G. W. Cottrell and R. K. Belew, “Latent Semantic Indexing is an Optimal Special Case of Multidimensional Scaling”, SIGIR Forum, 1992, pp. 161-167), and Bayesian regression (see R. E. Story, “An Explanation of the Effectiveness of Latent Semantic Indexing by Means of a Bayesian Regression Model”, Information Processing & Management 32(3) (1996), pp. 329-344).

According to Kleinberg, if a page is considered to have two qualities, one being “authoritativeness” and the other “hubness”, then the basic formula for calculating them is as follows: a page's authoritativeness is the sum of the hubness of all the pages pointing to it, and its hubness is the sum of the authoritativeness of all the pages it points to. (see J. Kleinberg, “Authoritative Sources in a Hyperlinked Environment”, Proceedings of the 9th Annual ACM-SIAM Symposium on Discrete Algorithms, 1998, pp. 668-677. Also appears as IBM Research Report RJ 10076, May 1997). Like Google's PageRank, this method uses only page-to-page relationship defined by hyperlinks, and is a form of link analysis. The DiscoWeb project at Rutgers, circa 1999, implements a sophisticated version of Kleinberg's algorithm (see B. D. Davison, A. Gerasoulis, K. Kleisouris, Y. Lu, H. Seo, W. Wang and B. Wu, “DiscoWeb: Applying Link Analysis to Web Search”, Proc. Eighth International World Wide Web Conference, 1999, pp. 148).

PageRank is a measure of a page's quality whose basic formula is as follows: A web page's PageRank is the sum of PageRanks of all pages linking to the page. PageRank can be interpreted as the likelihood a page is visited by users, and is an important supplement to exact matching. PageRank is a form of link analysis which has become an important part of web search engine design.

The merit of the design of Ranked IR can be examined according to the “Probability Ranking Principle” which states, “If a reference retrieval system's response to each request is a ranking of the documents in the collections in order of decreasing probability of usefulness to the user who submitted the request, where the probabilities are estimated as accurately as possible on the basis of whatever data have been made available to the system for this purpose, then the overall effectiveness of the system to its users will be the best that is obtainable on the basis of the data.” (see Rob77). Given that measure, it is interesting to observe that the current systems do not make use of “whatever data have been made available to the system” in performing topic searches. Thus, there is still a significant need to make better use of available data to improve the overall effectiveness of the system.

### SUMMARY OF THE INVENTION

The present invention provides systems and methods for facilitating searches, in which document terms are weighted as a function of prevalence in a data set, the documents are scored as a function of prevalence and weight of the document terms contained therein, and then the documents are ranked for a given search as a function of (a) their corresponding document scores and (b) the closeness of the search terms and the document terms. The weighting and document scoring can advantageously be performed independently from the ranking, to make fuller use of “whatever data have been made available.”

In preferred embodiments, the data set from which the document terms are drawn comprise the documents that are being scored. By weighting and scoring iteratively, the documents can be given greater weight as a function of their being found in higher scored documents, and the documents are can be given higher scores as a function of their including higher weighted terms.

All three aspects of the process, weighting, scoring and ranking, can be executed in an entirely automatic fashion. In preferred embodiments, at least one of these steps, and preferably all of the steps, are accomplished using matrices. In particularly preferred embodiments the matrices are manipulated by eigenvalues, and by comparing matrices using dot products. It is also contemplated that some of these aspects can be outsourced. For example, a search engine utilizing the falling within the scope of some of the claims herein might outsource the weighting and/or scoring aspects, and merely perform the ranking aspect.

It is also contemplated that subsets of the documents can be identified with various collections, and each of the collections can be assigned a matrix signature. The signatures can then be compared against terms in the search query to determine which of the subsets would be most useful for a given search. For example, it may be that a collection of journal article documents would have a signature that, from a mathematical perspective, would be likely to provide more useful results than a collection of web pages or text books.

The inventive subject matter can alternatively be viewed as comprising two distinct processes, (a) Doubly Ranked Information Retrieval (“DRIR”) and (b) Area Search. DRIR attempts to reveal the intrinsic structure of the information space defined by a collection of documents. Its central questions could be viewed as “what is this collection about as a whole?”, “what documents and terms represent this field?”, “what documents should I read first and, what terms should I first grasp, in order to understand this field within a limited amount of time?”. Area Search is RIR operating at the granularity of collections instead of documents. Its central question relates to a specific query, such as “what document collections (e.g., journals) are the most relevant to the query?”. Additionally, for each collection, Area Search can provide guidance to what terms and documents are the most important ones, dependent on or independent of, the given user query. Thus, if a conventional Web search can be called “Point Search” because it returns individual documents (“points”), then “Area Search” is so named because the results are document collections (“areas”). DRIR returns both terms and documents, thus named “Doubly” Ranked Information Retrieval.

In terms of objects and advantages, preferred embodiments of the inventive subject matter accomplish the following:

Formulate the two related tasks in topical research as the DRIR problem and the Area Search problem. Both are new problems that the current generation of RIR does not address and cannot directly transfer technology to;

Provide matrix based algorithms to determine weighting of terms, scoring of documents, and ranking of collections. Especially preferred embodiments utilize eigenvectors and singular vectors of the relevant matrices;

Provide metrics for comparing information retrieval techniques, enabling repeatable and scalable experiments, as well as the future development of optimization techniques;

Provide a mathematical foundation for analyzing the algorithms and the metrics. A primary mathematical tool is the matrix Singular Value Decomposition (SVD);

In both DRIR and Area Search, a document is represented as tuples of (term, weight. With Area Search, there is additional information on the membership of the document in a collection. No other information is available.

The tuples of (term, weight) are the results of parsing and term-weighting, two tasks that are not central to DRIR or Area Search. Parsing techniques can be applied from linguistics, artificial intelligence, to name just a few fields. Term weighting likewise can use any number of techniques. Area Search starts off with given collections, and does not concern itself with how such collections are created.

With Web search, a web page is represented as tuples of (word, position_in_document), or sometimes (word, position_in_document, weight) tuples. There is no awareness of collections, only a giant set of individual parsed web pages. Web search also stores information about pages in addition to their words. For example, the number of links pointing to a page, its last-modify time, etc.

Different internal data representations in DRIR/Area Search vs Web search lead to different matching and ranking algorithms. With DRIR and Area Search, matching is the calculation of similarity between documents (a query can be considered to be a document because it also is set of tuples of (term, weight)). This is what many RIR systems do, including some early Web search engines. The essence of the computation is making use of statistical information contained in tuples of (term, weight). Ranking is achieved by similarity scores.

With current Web search, matching is done by exact matching of words and proximity search. Since only words are known to Web search, typically the matching is so “exact” that not even stemming is used, e.g. “flowers” and “flower” return different results. Because the position of each word in the document is known, proximity search is possible. (Proximity search assigns a score depending on order and distance of the matching between query words and document words.) Typically statistical information of words in documents is not used. Web search is not aware of phrases but only words, although phrases in a user query does match up with those in a document, but this is an artifact of exact matching and proximity search.

Once exact matching and proximity search are done, factors “external” to words are used to boost rank or to break ties. Well known examples are (a) Google's PageRank based on hyperlinks, (b) CLEVER's Hubness/Authoritativeness based on hyper links, (c) AskJeeves/DirectHit's use of click feedback statistical information.

### BRIEF DESCRIPTION OF THE DRAWING

FIG. 1 is a matrix representation of document-term weights for multiple documents.

FIG. 2 is a mathematical representation of iterated steps.

FIG. 3 is a schematic of a scorer uncovering mutually enhancing relationships.

FIG. 4 is a sample results display of a solution to an Area Search problem.

FIG. 5 is a schematic of a random researcher model.

### DETAILED DESCRIPTION

### A. Doubly Ranked Information Retrieval (“DRIR”)

1. Input to DRIR

DRIR preferably utilizes as its input a set of documents represented as tuples of (term, weight). There are two steps before such tuples can be created: first, obtaining a collection of documents, and second, performing parsing and term-weighting on each document. These two steps prepare the input to DRIR, and DRIR is not involved in these steps.

A document collection can be obtained in many ways, for example, by querying a Web search engine, or by querying a library information system. One could also use a bibliographic source, where a citation is considered as a document, and citations of papers from a journal or a conference proceeding constitute a document collection.

Parsing is a process where terms (words and phrases) are extracted from a document. Extracting words is a straightforward job (at least in English), and all suitable parsing techniques are contemplated.

2. DRIR Problem Statement

The central problem statement of Doubly Ranked Information Retrieval is: given a collection of M documents containing T unique terms, where a document is tuples of (term, weight), a term is either a word or a phrase, and a weight is a non-negative number, find the r<<M most “representative” documents as well as the r^{t}<<T most representative terms. Since both ranked documents and terms are returned to users, this problem is called Doubly Ranked Information Retrieval.

Note that in the problem statement there is no user query. In our lexicon, obtaining the collection of documents is a “search” problem, and a user query is needed, but finding out what the collection “is about” is to “reveal”, to find properties “intrinsic” to the collection, therefore, it should be independent of any queries.

3. The Core Algorithm of DRIR

In preferred embodiments, the core algorithm of DRIR computes a “signature”, or (term, score) pairs, of a document collection. This is accomplished by representing each document as (term, weight) pairs, and the entire collection of documents as a document-term weight matrix, where rows correspond to documents, columns correspond to terms, and an element is the weight of a term in a document. The algorithm is preferably an iterative procedure on the matrix that gives the primary left singular vector and the primary right singular vector. (The singular vectors of a matrix play the same role as the eigenvectors of a symmetric matrix.) The components of the primary right singular vector are used as scores of terms, and the scored terms are the signature of the document collection. Similarly, the components of the primary left singular vector are used as scores of documents, the result is a document score vector. Those high-scored terms and documents are returned to the user as the most representative of the document collection. The signature as well as the document score vector has a clear matrix analytical interpretation: their cross product defines a rank-1 matrix that is closest to the original matrix.

In both DRIR and Area Search (described below), queries and documents are both expressed as vectors of terms, as in the vector space model of Information Retrieval. (see G. Salton, Automatic Text Processing: The Transformation, Analysis, and Retrieval of Information by Computer, Reading, Mass., Addison-Wesley, 1988). The similarity between two vectors is the dot product of the two vectors.

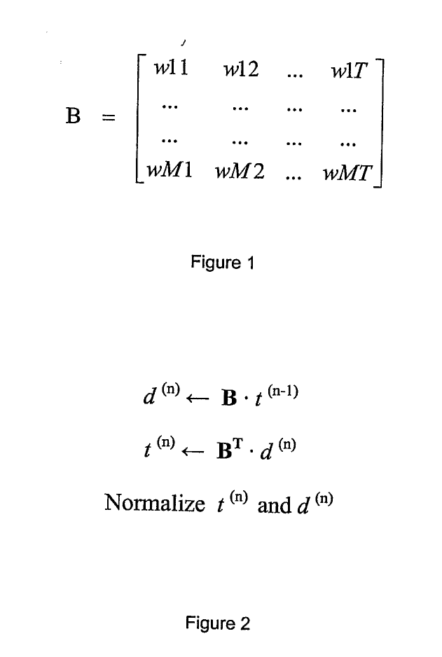

In FIG. 1, the tuples of all documents are put together to obtain a document-term weight matrix, denoted as B, where each row corresponds to a document, each column to a term, and each element to the weight of a term in a document. Following is a B matrix of M documents and T terms:

$$B = [ \begin{matrix}{w}_{11} & {w}_{12} & … & {w}_{1 T} \\ … & … & … & … \\ … & … & … & … \\ {w}_{M 1} & {w}_{M 2} & {w}_{MT} & {w}_{MT}\end{matrix} ]$$

where wᵢⱼ is the weight of the j^{th} term in the i^{th} document. All weights are non-negative real numbers.

A naive way of scoring documents is as follows:

Algorithm 1 A Naive Way of Scoring and Ranking Documents

| 1: for j ← 1 to M do | |
|---|---|
| 2: | add up elements in row i of matrix B. |
| 3: | use the sum as the score for document i. |

4: end for
5: Rank the documents according to the scores.

Similarly a naive way of scoring terms is as follows:

Algorithm 2 A Naive way of Scoring and Ranking Terms

| 1: for i ← 1toT do | |
|---|---|
| 2: | add up elements in column j of matrix B. |
| 3: | use the sum as the score for term j. |

4: end for
5: Rank terms according to their scores.

The document scoring algorithm is naive because it ranks documents according to their document lengths when an element in B is the weight of a term in a document. (Or the number of unique terms, when an element in B is the binary presence/absence of a term in a document.)

The term scoring algorithm is naive for a similar reason: if a term appears in many documents with heavy weights, then it has a high score. (However, this is not to say the algorithms are of no merit at all. A very long document or a document with many unique terms in many cases is a “good” document. On the other hand, if a term does appear in many documents, and it is not a stopword (a stopword is a word that appears in a vocabulary so frequently that it has a heavy weight but the weight is not useful in retrieval, e.g., “of,”, “and” in common English), then it is not unreasonable to regard it as an important term.)

To improve the algorithms, we first obtain the scores for documents using the naive algorithm, then use these document scores in calculating term scores in the following way: Given a term, instead of simply adding up its weights in all documents, add up its weights weighted by document scores. Once term scores are obtained, each document's score is updated by adding up its terms' weights weighted by the terms' scores. Then term scores can be updated with the new document scores, followed by document scores being updated with even newer term scores, so on and so forth.

A preferred solution to Area Search (see below) is built around DRIR's signature computation. Area Search has a set of document collections as input, and precomputes a signature for each collection in the set. Once a user query is received, Area Search finds the best matching collections for the query by computing a similarity measure between the query and each of the collection signatures.

Mathematically, we can call \vec{t} a signature of the collection. Signature plays an important role in both DRIR and Area Search, and finding a good signature of a collection is a central task. Any arbitrary term-score vector can serve as the signature. The difference is that they enjoy different mathematical properties, different procedural interpretations, and different performances with respect to certain metrics.

4. Iteration

Iteration of the DRIR algorithm is straightforward following the assumptions that an important term is a term that many important documents contain, and an important document is a document that contains many important terms. This observation when expressed in mathematics becomes \vec{d}←B·\vec{t}; \vec{t}←B^{T}·\vec{d}. Therefore the observation suggests an iterative algorithm: start with equal score for each term

t\vec{(o)}←(1,1 . . . 1,1);

\vec{d}⁽ⁿ⁾←B·\vec{t}⁽ⁿ⁻¹⁾

\vec{t}⁽ⁿ⁾←B^{T}·\vec{d}⁽ⁿ⁾

Normalize \vec{t}⁽ⁿ⁾ and \vec{d}⁽ⁿ⁾

and iterate the following steps (see also FIG. 2):

Given the document-term matrix BεR^{M×T}, the iteration produces a converging \vec{t}εR^{T×1} and \vec{d}εR^{M×1} where \vec{t} is the term score vector and \vec{d} the document score vector.

We also refer to a term score vector of a document collection as the signature of the collection.

Algorithm 3 Scorer: An Iterative Procedure
for Scorings of Terms and Documents

| 1: Initialized:\vec{t}← (1,1,...,1_{T}),\vec{d}← (1,1,...,1_{M}) | |
|---|---|
| 2: LOOP: | |
| 3: \vec{t}← B^{T} \vec{d} | |
| 4: \vec{d}← B\vec{t} | |
| 5: Normalize so that \vec{t}\vec{t}^{T} = 1, \vec{d}\vec{d}^{T} = 1 | |
| 6: if \vec{t} and \vec{d} converge then | |
| 7: | Output \vec{t} and \vec{d}, exit. |
| 8: else | |
| 9: | Go LOOP |

10: end if

The convergence can also be shown by the following equilibrium equations:

\vec{t}=cₜ·B^{T}B\vec{t}, \vec{tt}^{T}=1

\vec{d}=c_{d}·BB^{T}\vec{d}, \vec{d}\vec{d}^{T}=1

where cₜ and c_{d} are constants.

These equations are similar to the definition of an eigenvector, showing that \vec{t} converges to the primary eigenvector of BB^{T}, and \vec{d} converges to the primary eigenvector of BB^{T}, as can be shown by standard Matrix Analysis theory. (see G. H. Golub and C. F. Van Loan, Matrix Computations, 3rd ed., Baltimore, Johns Hopkins University Press, 1996).

In order to converge to the primary eigenvector, however, the starting vector must have components in the direction of the primary eigenvector, a requirement that is met by the above chosen initial values for \vec{t} and \vec{d}.

Since the value of the converged vectors does not rely on initial conditions but only on the matrix itself, they indeed help to represent an “intrinsic” aspect of the document-term relationship defined by the matrix.

The Singular Value Decomposition (SVD) of a matrix B, UΣV^{T}=B decomposes the matrix, where

U=[\vec{u}₁, . . . , \vec{u}_{M}]εR^{M×M}, V=[\vec{u}₁, . . . , \vec{u}_{T}]εR^{T×T}

are orthogonal matrices consisting of the left singular vectors \vec{u}ᵢ, and the right singular vectors

σₘₐₓ≡σ₁≧ . . . σ≡σₘᵢₙ>σᵣ₊₁= . . . =σ=0,

respectively. Σ=(σ₁, . . . , σₖ) where k is the rank of B. (See the Appendix for a review of the matrix SVD.)

The SVD of the matrix B is related to the eigenvectors of B^{T}B and BB^{T} in the following way: the left singular vectors \vec{u}ᵢ(B) of B are the same as the eigenvectors \vec{u}ᵢ(BB^{T}B), and the right singular vectors \vec{u}ᵢᵢ (B) are the same as the eigenvectors \vec{u}ᵢ(B^{T}B). Thus, we could also develop an interpretation of \vec{t} and \vec{d} based on the SVD of B.

The cross product of \vec{t} and \vec{d}, \vec{d}\vec{t}^{T} is the closest rank-1 matrix to the document-term matrix by SVD. The cross product can be interpreted as an “exposure matrix” of how users are able to examine the displayed top ranked terms and documents. Thus it could be said that the document and term score vectors are optimal at “revealing” the document-term matrix that represents the relationship between terms and documents. With similar reasoning, the cross product of the document score vector “reveals” the similarity relationship among documents, and the term score vector does the same for terms.

DRIR's iterative procedure does at least two significant things. First, it discovers a mutually reinforcing relationship between terms and documents. When such a relationship exists among terms and documents in a document collection, high scored terms tend to occur in high scored documents, and score updates help further increase these documents' scores. Meanwhile, high scored documents tend to contain high scored terms and further improve these terms' scores during updates.

Second, the iterative procedure calculates term-to-term similarities and document-document similarities, respectively, which is revealed by the convergence condition \vec{d}=c_{d}BB^{T}\vec{d} and \vec{t}=cₜB^{T}B\vec{t}, where BB^{T} can be seen as a similarity matrix of documents, and B^{T}B a similarity matrix of terms. The similarity between two terms is based on their co-occurrences in all documents, and two documents' similarity is based on the common terms they share.

At the end of the iterative procedure, a high scored term thus indicates two things: (1) its weight distribution aligns well with document scores: if two terms have the same total weights, then the one ending up with a higher score has higher weights in high scored documents, and lower weights in low scored documents; (2) its similarity distribution aligns well with term scores: a high scored term is more similar to other high scored terms than to low scored terms.

Similarly, a high scored document has two features: (1) the weight distribution of terms in it aligns well with term scores: if two documents have the same total weights, then the one with a higher score has higher weights for high scored terms, and lower weights for low scored terms; (2) its similarity distribution aligns well with document scores: a high scored document is more similar to other high scored documents than to low scored documents.

### B. Interpretation of DRIR Scores

1. Two Meanings of High Scores

A high score for a term generally means two things: (1) it has heavy weights in high-scored documents; (2) it is more similar to other high-scored terms than low-scored terms.

This can be shown by the equations of the iterative procedure.

\vec{t}=cₜB\vec{d} (1)

or equivalently

$${t}_{k} = {\sum }_{{page}_{j} {hasterm}_{k}} {b}_{kj} {d}_{j}$$

The k^{th} element of \vec{t} is the score for term k, which is the dot product of \vec{d} and the k^{th} row of B. Therefore for term k to have a large score, its weights in the n documents as expressed by the k^{th} row of B, shall point to the similar orientation (or align well with) the document score vector \vec{d}.

It helps term k to get a high score if it has heavy weights in high-scored documents. On the other hand, it hurts its score if the term has heavy weights in low-scored terms. Its score is the highest if it has heavy weights in high-scored documents, and light weights in low-scored documents, given a fixed total of weights.

Similar analysis is applied to

\vec{d}=c_{d}B^{T}\vec{t}

or equivalently,

$${d}_{j} ← {\sum }_{{page}_{j} {hasterm}_{i}} {b}_{ji} {t}_{i}$$

Document d tends to have a high score if it contains high-scored terms with heavy weights. Its score is hurt if it contains low-scored terms with heavy weights. The score is the highest if the document contains high-scored terms with heavy weights and low-scored terms with light weights, given a fixed total of weights.

\vec{t}←B^{T}B\vec{t} (2)

The product of B^{T} and B is a T×T matrix that can be seen as a similarity matrix of terms. The element (i,j) is the dot product of the i^{th} row of B^{T}, which is the same as the i^{th} row of B, and the j^{th} column of B, and its value is a similarity measure of term i and j based on these two terms' weights in the M documents.

Denote S≡B^{T}B as the term-term similarity matrix, then the score of term k, namely the k^{th} element of \vec{t}, is the dot product of the k^{th} row of S and \vec{t}. For term k, given a fixed total amount of similarity, if its similarity vector, namely the k^{th} row of S points in a similar direction as the term score vector \vec{t}, then its score is large.

In other words, the fact that term k is similar to other high-scored terms helps its score. Its being similar to other low-scored terms hurts its score. Its score is the highest if term k is more similar to high-scored terms than to lower scored ones, given a fixed total amount of similarities. This is in accordance with a graph interpretation of eigenvectors. As shown in the Appendix, the magnitudes of the components of the primary eigenvector has the following interpretation. On the graph defined by a square matrix, the number of walks of length k, when k becomes large, between nodes (i,j) depends on the product of the i^{th} and j^{th} component of the primary eigenvector.

A similar analysis can be applied to

\vec{d}←BB^{T}\vec{d}

When document d is similar to other high scored documents, its score tends to be high. If it is similar to other low-scored documents that its score tends to be low. The document's score is the highest if it is more similar to high-scored documents than to lower-scored ones, given a fixed total amount of similarities.

2. The Score Vectors Best Reveal the Document-Term Matrix

According to the SVD, the cross product of the term score vector and the document score vector, \vec{d}\vec{t}^{t} are the best rank-1 approximate to the original document-term matrix. One way of understanding the impact of this statement is the following thought experiment: Suppose a term's score indicates the frequency by which the term is queried. Also suppose a document's score indicates the amount of exposure it has to users. Multiplying a term's score and the document score vector therefore gives the amount of document exposure due to the term. An “exposure matrix” is constructed by going through each term and multiplying its score and the document score vector.

By SVD, we can show that the document exposure matrix is the best rank-1 approximate to the document-term weight matrix. As long as a term or a document is assigned a score, which is a scalar value, the best score vectors are the ones our procedure finds.

Therefore the term score vector and the document vector are the optimal vectors in “revealing” the document-term weight matrix which reflects the relationship between terms and documents.

3. Scorer Uncovers Mutually Enhancing Relationships

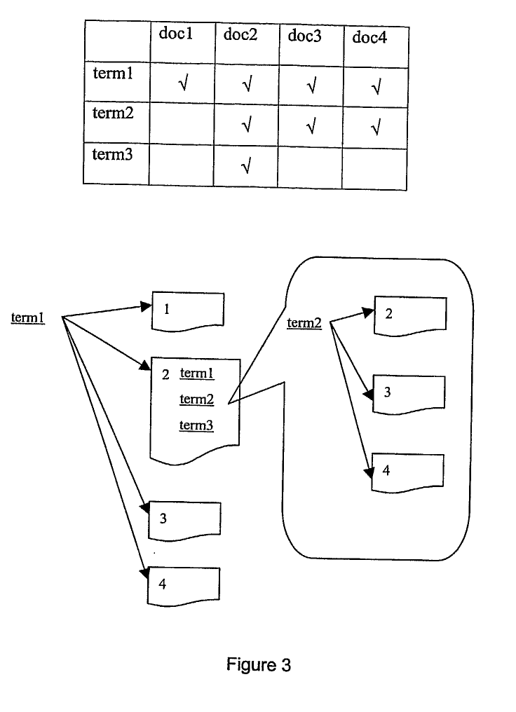

In FIG. 3, a random surfer starts with term₁. If he lands on doc₂, he has the choice of three terms: term₁, term₂, and term₃. If he chooses, term₂, then the pages to choose from are doc₁, doc₂ and doc₄. The score of term₂ is determined by the relationship between the terms and the documents.

Large-Large” Relationship. Suppose term₂ has a large weight in doc₂, then once the surfer is on doc₂, there is a large chance for him to pick term₂. term₂, on the other hand, happens to appear in doc₂, doc₃, and doc₄.

If it also happens that among these three documents, term₂ has the largest weight in doc₂, then a “large-large” mutually reinforcing relationship exists between term₂ and doc₂: once the surfer lands on doc₂, there is a large chance to pick term₂, and once term₂ is picked, there is a large chance to land on doc₂ once again.

Large-Small” Relationship. If term₂ is important in doc₂ compared with other terms, but not important compared with other documents, then the positive feedback is not as strong as above: when the surfer is on doc₂, he has a large chance to pick term₂, however, once term₂ is picked, there is a larger chance to go off on doc₃ or doc₄.

Small-Large Relationship. If term₂ is not important in doc₂ compared with other terms, but important compared with other documents, then again the positive feedback is not as strong: when the surfer is on doc₂, he has a small chance to pick term₂, although once term₂ is picked there is a larger chance to land on doc₂ again.

Small-Small” Relationship. If term₂ is not important in doc₂ compared with other terms, and not important compared with other documents, then the relationship is still mutually reinforced, but the result is term₂ that does not benefit from doc₂.

With the above analysis, only the “large-large” relationship helps the score for a term. If a term does contain high-scored documents, and there are “large-large” relationships, then the term also will be high-scored. Since the reinforcement is mutual, the argument applies also to documents, namely, if a document contains high-scored terms and there are “large-large” relationships, then the document will be scored high.

Consider two extreme cases that illustrate how mutually reinforcing relationship is at work.

The unit square matrix
With this special case, the number of documents and the number of terms are the same, each document contains exactly one unique word. Therefore between a document and the word it contains, there is a large-large mutual reinforcing relationship, with is the strongest possible with this matrix.

A matrix whose elements are all the same
In this case, there is only a ‘flat’ relationship between terms and documents, and the mutually reinforcing relationship is the weakest. The following algorithm finds large-large reinforcing relationships.

Algorithm 4 Large-Large: Finding Large-large
Reinforcing Relationship

| 1: for each row i in the document-term matrix B do | |
|---|---|
| 2: | find top ranked elements of the row |
| 3: | for each such element (i, j) do |

| | |
|---|---|
| 4: | if (i, j) is top ranked in column j then |

| | |
|---|---|
| 5: | output (i, j) as having large-large reinforcing |

relationship

| | |
|---|---|
| 6: | end if |

| | |
|---|---|
| 7: | end for |

8: end for

To implement the algorithm with “real world” data, both the inverted index and forward index are needed. The inverted index is used when Line 2 is implemented, and the forward index is used when Line 4 is implemented.

4. A Markov Chain Analogy

Recall that BB^{T} is a document-document similarity matrix, and that \vec{d}, DRIR's document score vector, is its eigenvector. This leads to a Markov Chain analogy.

Suppose each row in BB^{T} is normalized so that its first norm becomes 1 (i.e., each row's elements add up to 1), note also that all elements are non-negative. This new matrix is the probability matrix of a Markov Chain.

This Markov Chain's transition probabilities have the following interpretation: a visitor to the i^{th} state (i.e., the j^{th} document) transits to the document with a probability equal to how similar the two documents are. The converged value of each state (i.e, each document) indicates how many times the document has been visited, or, how “popular” the document is. While the result is not the same as the eigenvector of BB^{T}, we suspect that they shall be strongly related.

For terms, the interpretation is similar.

### C. Area Search

The central question of Area Search is that “given multiple document collections and a user query, find the most relevant collections”. Further, for each collection, find a small number of documents and terms for the user to further research.

1. Input to Area Search

With our current design, Area Search requires each document be represented by tuples of (term, weight), the same requirement by DRIR.

Area Search further requires a data source to contain multiple collections, and without loss of generality, for each document to belong to one and only one collection. In our experiment, we use a bibliographic source, where journals (and conference proceedings) are “natural” collections, and a paper belongs to one journal (or conference proceeding).

Area Search starts with prepared document collections. It does not concern itself with how the collections are created, nor how parsing and term-weighting are done.

2. Problem Statement of Area Search

Given multiple document collections (e.g. journals), each collection consists of documents of tuples (term, weight) and without loss of generality, a document belongs to one and only one collection. Given a user query (i.e. a set of weighted terms), find the most “relevant” n collections, and for each collection, find the most “representative” r documents and r terms, where r,r^{t} are small.

3. Sample (n,r) Results Display

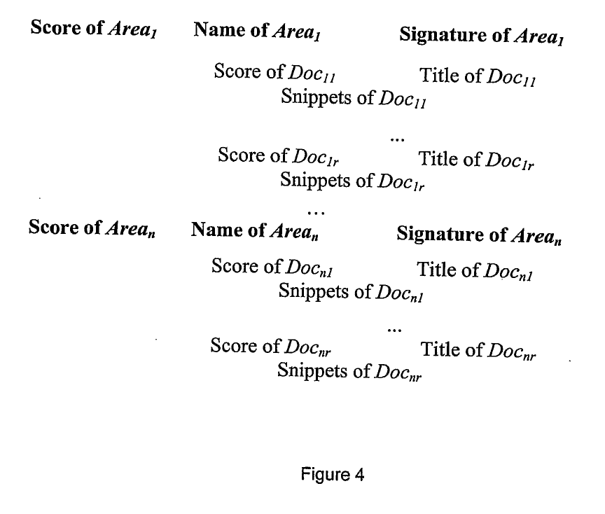

FIG. 4 shows a use case that is a straightforward solution to the Area Search problem. A user submits a query and is shown the following (n,r) Results Display:

With this design, given a query, n areas are returned, ranked by an area's similarity score with the query. For each area, the similarity score, the name of the area (e.g., name of a journal) and the signature of the area (i.e., terms sorted by term-scores) are displayed. Within each area, r documents are displayed. These r documents are considered worthwhile for the user to further explore. For each document, its score, title, and snippets are displayed, much like what a Web search engine does. In all, n areas and n×r documents are displayed.

There are certainly many variations to this basic scheme. For example, r could be dependent on an area's rank, so that the top 1 area displays more documents than, say, the top 10 area.

### D. A Solution Based on Collection Signatures

To serve the general goal of Area Search, there are many possible algorithms. Our proposed algorithm is effective and low in computational requirements. At the center of the solution is the calculation of the signature for each collection.

The algorithm is as follows:

Pre-computation:

Prepare a signature for each collection;

Assign as score to each document its similarity with the signature;

Serving queries:

Given a query, compute the similarity between the query and each of the collection signatures;

Return the following:

(i) The n collections with the highest similarity scores;

(ii) for each collection, the r documents and r^{t} keywords as pre-computed.

The dot product of two vectors is used as a measure of the similarity of the vectors.

With this proposed solution, the areas to be returned are dependent on the user query. However, within each area, the returned documents and terms are pre-computed and are independent of the user query. Our solution emphasizes the fact that what an area (e.g., a journal) is about as a whole is “intrinsic” to the area, and thus should not be dependent on a user query. Having stated that, we acknowledge that it is also reasonable to make the returned documents and terms dependent on the user query, with the semantics of “giving the user those most relevant to the query” from a collection.

With our solution, the performance of an Area Search system is entirely dependent on how the signatures are computed, or as we call it the “signature scheme”. DRIR is compared with other signature schemes in our theoretical analysis and experiments.

### E. Metrics

For any Information Retrieval system the ultimate evaluation is a carefully designed and executed user study, where each human evaluator is asked to make a judgment call on the returned results. In such a study of DRIR, the evaluator would be asked to assign a value of “representativeness” of the returned terms and documents. With Area Search, the evaluator would judge how relevant the returned areas are to a user query, and for each area, how important the returned terms and documents are, in relation to the user query, or alternatively independent of the query.

Our Representativeness Error measures how representative the DRIR results are. Via Singular Value Decomposition we have shown that DRIR's signature possesses theoretical optimality with this metric. Further we have developed a user-based formulation of the metric which takes into consideration how much attention users pay to displayed results on computer screens. Further, Representativeness Error is parameterized by r, where r is the number of top documents returned to a user.

To evaluate Area Search, we need first to solve the issue of getting a large number of reasonable user queries, and second to judge the relevance between a user query and a document collection's signature. We solve both by taking advantage of one objective fact: a document belongs to one and only one collection. This is certainly true for citations and journals, and it can be set so in artificial data. Taking advantage of this fact, we use each document as a user query. This way a rich set of user queries is obtained, and the relevance value is derived from the membership of a document in a collection.

The returned results of Area Search are parameterized by n and r, where n is the number of areas returned, and r the number of documents returned for each area. (In our discussions, “area” and “collection” are used interchangeably.)

Consider the situation where a document is used as a query, and an Area Search system returns the (n,r) results. If the document (serving as a query) is among the nr documents returned, then we say there is a hit. Repeat this for all documents, and add up all hits and we obtain the Hits metric, which is parameterized by n and r. Hits is reminiscent of “recall” (the number of returned relevant results divided by the total number of relevant results) in Information Retrieval, but it has a much more complex behavior due to the relationship among collections.

Hits helps to measure only one aspect of the performance of a signature. When the “true” collection that a document belongs to is not returned, but collections that are very similar to its “true” one are, Hits does not count them. However from the user's point of view, these collections might well be relevant enough. We introduce the metric WeightedSimilarity which captures this phenomenon by adding up the similarities between the query and its top matching collections, each weighted by a collection's similarity with the true collection. Again it is parameterized by n and r. WeightedSimilarity is reminiscent of “precision” (the number of returned relevant results divided by the total number of returned results), but just like Hits vs recall, it has a complex behavior due to the relationship among collections.

A metric of Information Retrieval should also consider the limited amount of real estate at the human-machine interface because a result that users do not see will not make a difference. In all the three metrics, the “region of practical interest” is defined by small n and small r.

1. The Representativeness Error Metric

Our Representativeness Error Metric measures how “representative” a set of documents are given a signature of the document collection. We introduce a metric, the “Representativeness Error”, which measures how “representative” the terms in the signature and the top ranked documents are of a document collection. It does so by measuring the error between the signature and the documents. In addition, by recognizing how users react to top ranked results, we propose “Visibility Representativeness Error”, a variation to the basic formulation, that considered how “visible” each displayed result is to users.

Denote as usual B the M×T document-term matrix. A signature is the vector

\vec{t}=(t₁, . . . , tᵣ)

where T is the total number of terms (or columns of B) is a vector of all the terms, and each component is non-negative. (Equivalently a signature can be expressed as tuples of (term, score), where scores are non-negative.)

Note any vector of the terms could be used as a signature, for example, a vector of all ones: [1, . . . , 1]. Thus it is necessary to find ways of measuring how good a signature is. We start by understanding how a signature is used.

Once we have a signature \vec{t}, it will be used to obtain the scores of the M documents as follows. Given the i^{th} document (which we represent as \vec{r}ᵢ, the i^{th} row of B), its score dᵢ is calculated as

dᵢ=\vec{r}ᵢ\vec{t}^{T}

the dot product between \vec{r}ᵢ and the signature. (The dot product of two vectors is often used as a similarity measure between two vectors.) Written in vector form, the scores of all the M documents is what we define as the document-score vector:

\vec{d}=B^{T}\vec{t}

All elements in \vec{d} are also non-negative because all elements in \vec{t} and B are non-negative.

The top r documents are those r documents whose scores are the highest, i.e., whose components in \vec{d} are the largest. Similarly, the top r² terms refer to those r² terms whose scores are the highest, i.e., whose components in \vec{t} are the largest.

Intuitively, a signature is the most representative of its collection when it is closest to all documents. Since a signature is a vector of terms, just like a document, the closeness can be measured by errors between the signature and each of the documents in vector space. When a signature “works well”, it should follows that

The error is small.

The signature is similar to the top rows. When the signature is similar to the top rows, it is close to the corresponding top ranked documents, which means it is near if not at the center of these documents in the vector space, and the signature can be said of being representative of the top ranked documents. This is desirable since the top ranked documents are what the users will see.

Our metric Representativeness Error measures this closeness. For a particular document whose row is \vec{r}ᵢ and whose score dᵢ, the Representativeness Error between the document and the signature \vec{t} is defined as

Σ(rᵢⱼ−dᵢtⱼ)²

We add these errors together for all M documents and get the total error, RepErr(M)

$$RepErr ( M ) = {‖ \begin{matrix}{{r}_{1}}^{->} & - & {d}_{1} {t}^{->} \\ & … & \\ {{r}_{M}}^{->} & - & {d}_{M} {t}^{->}\end{matrix} ‖}_{F}^{2}$$

which is an equivalent way of writing

RepErr(M)=∥B−\vec{d}\vec{t}^{T}∥_{F}²

where “F” denotes the Frobenius form, which is widely used in association to the Root Mean Square measure in communication theory and other fields.

The meaning of the item is dᵢ·\vec{t} illustrated here. First, the document score dᵢ=\vec{r}·\vec{t}, is the product of (a) the length of the projection of \vec{r} onto \vec{t} and (b) the length of \vec{t}. In this case, the length of \vec{t} is 1 by its definition. Thus dᵢ·\vec{t} is \vec{t} scaled by the length projection of \vec{r}ᵢ onto \vec{t}.

2. The DRIR Signature is Optimal for RepErr(M)

We claim that the DRIR signature is optimal RepErr(M) for because with DRIR, \vec{d}=σᵢ\vec{u}₁, and \vec{t}=\vec{u}₁, and so the error becomes ∥B−σ₁\vec{u}₁\vec{u}₁^{T}∥_{F}², which by Singular Value Decomposition equals Σ₂^{k}σᵢ² where k is the rank of the matrix in question. This is the minimum value for all possible \vec{d}εR^{m×1} and \vec{t}′εR^{T×1} vectors.

3. Error Introduced by B₁

We further analyze the error cause B₁, which is the primary component of B in SVD.

Given a query which we denote by \vec{q}=(t₁ . . . , tᵣ), where tᵣ is a weight on the i^{th} term, what's the difference between its similarity with B and its similarity with B₁? We define this error as ∥\vec{q}(B−B₁ ∥_{F} where ‘F’ is the Frobenius norm of a matrix.

We give upper- and lower-bounds of this error.

For any m×n matrix A, it is known that

∥A∥₂≦∥A∥_{F}≦\sqrt{n}∥A∥₂

Also, given two matrices, A and B, it is known for the 2-norm,

∥AB∥₂≦A∥₂∥B∥₂

Further, for any vector \vec{Ε}≠0,

$$min \frac{{‖ A {x}^{->} ‖}_{2}}{{‖ {x}^{->} ‖}_{2}} = {σ}_{1}$$

where σ₁ is the largest singular value for matrix A.

Thus we have a lower bound,

σ₂∥\vec{q}∥≦∥\vec{q}(B=B₁)∥₂≦|\vec{q}(B−B₁)∥_{F}

and an upper bound,

∥\vec{q}(B−B₁)∥_{F}≦\sqrt{n}∥\vec{q}(B−B₁)∥₂=\sqrt{n}∥\vec{q}∥₂σ₂

4. RepErr(r)

What is of practical interest is the error introduced by the top r documents, denoted as RepErr(r):

$$RepErr ( r ) = {‖ \begin{matrix}{{r}_{1}}^{->} & - & {d}_{1} {t}^{->} \\ & … & \\ {{r}_{r}}^{->} & - & {d}_{r} {t}^{->}\end{matrix} ‖}_{F}^{2}$$

where r₁ . . . r² are the highest scored documents. RepErr(r) is of practical interest because users see only the top r documents that are displayed at the human-machine interface.

Further, not all terms are shown to users but only the top r² Thus we amend the metric to reflect that, namely, we introduce RepErr(r,r²):

$$RepErr ( r , {r}^{′} ) = {‖ \begin{matrix}{{r}_{1}}^{->} & - & {d}_{1} {{t}_{r}^{′}}^{->} \\ & … & \\ {{r}_{r}}^{->} & - & {d}_{r} {{t}_{r}^{′}}^{->}\end{matrix} ‖}_{F}^{2}$$

where r₁ . . . r₂ are the highest scored documents, and \vec{t}contains the highest scored terms.

It is not trivial to show the theoretical optimality of RepErr(r) and RepErr(r,r²). Instead, we demonstrate with experiments that DRIR indeed does better than other signatures. We also discuss a sufficient condition for small errors in the following.

5. A Sufficient Condition for Low RepErr(r)

For DRIR, the is RepErr is ∥B−B₁∥_{F}.

When written in rows, the i^{th} row becomes Σ_{z}^{k}∥\vec{σ}ᵤ ∥_{F}. Suppose these rows are ranked by document score σ₁u.

Consider the top r ranked rows (documents), namely u₁₁≧ . . . ≧u . . . ≧u. By inspecting Σ∥σu∥_{F}, i=1, . . . r, it is recognized that the following are sufficient conditions for the top r to have small errors:

the absolute values of u are small, i=1, . . . , r, and,

σ₂>>σ₃≧ . . . σₖ, where k is the rank of matrix B.

6. Visibility RepErr: A User-based Formulation

It is a common observation that users pay attention only to top results. A recent study by search marketing firms Enquiro and Did-it and eye tracking firm Eyetools confirmed this observation. (see Eyetools, Inc., “Eyetools, Enquiro, and Did-it uncover Search's Golden Triangle” 2005. http://eyetools.com/inpage/research_google_eyetracking_heatmap.htm). The eye tracking study found that 100% of the 50 participants in the study viewed the top 3 results returned by Google, 85% of them viewed the Rank 4 result, progressively fewer looked at results down the rank, and only 20% of them viewed the Rank 10 result. The percentages are listed in Table 1.

TABLE 1
Visibility of Rankings

| | |
|---|---|
| Rank 1 | 100% |
| Rank 2 | 100% |
| Rank 3 | 100% |
| Rank 4 | 85% |
| Rank 5 | 60% |
| Rank 6 | 50% |
| Rank 7 | 50% |
| Rank 8 | 30% |
| Rank 9 | 30% |
| Rank 10 | 20% |

This tells us that at the Results Display interface, the score of a document does not directly impact user's experience. Rather, what matters is its rank, or more accurately, the userâ [symbol] ™s attention as a function of the rank. Namely, if a document is displayed as number one, it does not matter whether it scores 0.9 or 0.5, the document always receives 100% attention from users (namely all users look at it).

We now develop a user-oriented formulation for Representative Error. In the formulations discussed earlier, the difference of a document and the signature is expressed as:

Σ(rᵢⱼ−dᵢtⱼ)²

where dᵢ is the score of the document.

Using the results from the study, we replace document scores with “visibility scores” of displayed results, namely Visibility Representativeness Error.

$$Visibility RepErr = {‖ \begin{matrix}{{r}_{1}}^{->} & - & {v}_{1} {t}^{->} \\ & … & \\ {{r}_{10}}^{->} & - & {v}_{10} {t}^{->}\end{matrix} ‖}_{F}^{2}$$

where only the top 10 documents are considered (since a typical results display interface shows 10 results), and (u₁, . . . , u₁ₙ) are “visibility scores” for each rank.

The visibility scores that we used are derived from studying user's reaction to Web search results. This is not ideal for DRIR to use since DRIR is applied to document collections thus in real world applications, most likely DRIR's data sources are of meta data or structured data, (For example in our experiments, we use a bibliographic source) not unstructured Web pages. We chose to use these visibility scores since that data was readily available in the literature. In the future, we intend to use more appropriate user visibility scores.

7. Metrics: Hits(n,r) and WeightedSimilarity(n,r)

To evaluate the performance of an Area Search system, we again have the choice of deploying human evaluators and using precision and recall as the metrics.

However, since by definition Area Search deals with multiple areas (hundreds or even thousands), each of which having hundreds if not thousands documents, the amount of evaluation work is large. Also many of the areas involve specialized knowledge, which denies the use of “common” human evaluators.

We thus propose two metrics that can be automatically computed. An additional benefit of using the metrics is that they can also be theoretically analyzed.

A metric for Area Search shall have two features. First, it shall solve the issue of user queries. The issue arises because on one hand, the performance of Area Search is dependent on user queries, but on the other hand, there is no way to know in advance what the user queries are. The second feature is that a metric should take into consideration the limitation at the human-machine interface. Since Area Search uses the (n,r) Results Display, a metric that is parameterized by n and r can model the limited amount of real estate at the interface by setting n and r to small values.

8. Hits(n,r)

The metric Hits(n,r) is defined as follows:

Given n and r;

Use each document as a query, and get the (n,r) results from the Area Search system;

if the document is among the documents, count this as a hit.

Add up all hits to obtain the value of Hits(n,r).

The metric is parameterized by n and r, and uses documents as queries. A hit means two things. First, the area to which the document belongs has been returned. Second, this document is ranked within top r in this area. The metric takes advantage of the objective fact that a document belongs to one and only one area.

Hits(n,r) parallels to recall of traditional Information Retrieval but with distinctions. With recall, a set of queries has been prepared, and each (document, query) pair is assigned a relevance value by a human evaluator. Hits takes a document and uses it as a query, and the “relevance” between the “query” and a document is whether the document is the query or not.

The behavior of Hits is more complex that that of recall. Consider under what conditions a “miss” happens. A miss happens in two cases. First, the document's own area does not show up in the top n. Second, when its area is indeed returned, the document is ranked below r within the area. These conditions lead to interesting behavior. For example, a Byzantine system can always manage to give a wrong area as long as n≦N where N is the total number of areas, making Hits always equal to 0. However, once n=N, the real area for a document is always returned, and Hits is always the maximum.

The region of practical interest, in light of the limited real estate at human-computer interface, is where both n and r are small.

By theoretical analysis, we obtained sufficient conditions where Hits(n,r) does well for DRIR. The predicted behavior was shown through experiments on artificial data.

We also experimented on real data, which showed that DRIR does better in Hits(n,r) than other signature schemes when both n,r are small.

9. WeightedSimilarity(n)

Sometimes the system does not find the area where a document belongs but a very similar area. Hits does not consider this situation. However from the user's point of view, a very similar area might well be as useful as the real one. Thus we developed a WeightedSimilarity(n) metric to assess the quality of the n returned areas for a given query. It is obtained as follows: for each document, use it as a query denoted as \vec{q}. Suppose the document belongs to Areaᵣₑₐₗ. Get from the Area Search system the top n areas for the document, and calculate the “weighted similarity” between the query and the n areas:

S

where each item is the similarity between the query \vec{q} and a returned area Areaᵢ, weighted by the similarity between Areaᵢ and Areaᵣₑₐₗ. An area is represented by its signature which is a vector on terms. Similarity between two vectors is the dot product of the two.

Add up the value for all documents to obtain the WeightedSimilarity(n) for the collection of M documents:

Σ_{d=}^{M}Σᵢ₌₁ⁿsim(q_{d},Areaᵢ)sim(Areaᵢ,Areaᵣₑₐₗ)

WeightedSimilarity(n) parallels to precision of traditional Information Retrieval. With precision, the ratio between the number of relevant results and the number of displayed results indicates how many top slots are occupied by good results. Just as with recall, it requires pre-defined user queries, as well as human judgment of the relevance between each (query, document) pair. With WeightedSimilarity(n), the weighted similarity between a document and an area within the top n returned areas plays the role of relevance between a query and a document, and queries are the documents themselves.

WeightedSimilarity(n) is further parameterized as WeightedSimilarity(n,r), where r indicates that only documents ranked in top r with their own areas are included in the summation. The (n,r) parameters correspond to the (n,r) Results Display. Again, the region of practical interest is where both n,r are small, since a document within this region is more likely to be representative of its collection.

In our experiments, we found a behavior similar to that of Hits(n,r), that DRIR does better than other signature schemes when both (n,r) are small.

### F. Experiments

The way signatures are computed lies at the core of both DRIR and Area Search. Once signatures are computed, each document's score is simply the dot product between its weight vector and the signature. And in Area search, a collection's relevance to a query is the dot product between the query and the signature. Therefore evaluating DRIR and Area Search is evaluating the quality of signatures.

The goal of the experiments is to evaluate DRIR against two other signature schemes on the three proposed metrics, Representativeness Error for DRIR, and Hits, and WeightedSimilarity for Area Search. We used a bibliographic source as real data to experiment on. We also conducted experiments on artificial data with a secondary goal of observing the interactions between signature, characteristics of data, and performance of metrics. These experiments help us to confirm our theoretical predictions on the metrics, and to gain understanding on how to simulate real data.

We obtained theoretical results on the three metrics. However, the information landscape for an Information Retrieval system is inherently so complex that theoretical results cannot adequately describe it. We thus conducted experiments on both artificial and real data, with special attention to performance in the region of practical interest (small n and small r). Experimenting on artificial data allowed us to test the theoretical results we obtained and gain insight into modeling of real data. Experimenting on real data, on the other hand, helped to demonstrate possible applications of DRIR and Area Search.

The generation of the artificial data was guided by our theoretical analysis of the algorithms and the metrics. Generation algorithms were designed for creating individual document-term weight matrices, as well as multiple matrices with controlled overlapping. Via theory, the performance of the three metrics was linked to parameters with which data are generated, and the experiments confirmed these linkages. These designs and experiments provided guidance to understanding the real data.

Our experiments on real data were conducted on more than 20,000 citations downloaded from ACM's portal web site. The way the citations were gathered ensures that most of the citations are in the general field of Computer Science. Two competing signature computation schemes were compared against DRIR, and the experiments showed that DRIR does better in the region of practical interest in different experimental settings.

Both kinds of experiments helped to show the performance of DRIR in comparison to other signature schemes. With the three metrics, over a number of different settings, it was shown that DRIR does better when both n,r are small, which is the region of practical interest.

1. Artificial Data

There are practically an unlimited number of parameters for generating artificial data. With the guidance of our theoretical analysis, we decided upon a number of “knobs”, namely tunable parameters, to be used. Combinations of these parameters were iterated through and data were collected on (a) the statistical characteristics of each data set, and (b) performance of the three metrics. The results' relationship with the tunable parameters are detected and discussed.

The experiments confirm several of our theoretical predictions. They also provide building blocks for simulating the real data.

2. Real Data

We selected a bibliographic source as the real data to experiment on. Such a source is used because

By using the index terms of each citation, parsing is bypassed;

Journals and conference proceedings are “naturally occurring” collections;

The fact that a paper belongs to only one collection can be utilized.

We downloaded 20,000 citations from ACM's “The Guide to Computing Literature” site, starting by querying the site with researchers from ten computer science departments. Three term-weighting schemes were devised by us to deal with hierarchically arranged index terms. After term-weighting, the document-term B matrices for each journal/conference proceedings was obtained.

Our results show that DRIR does better than other signature schemes for Hits(n,r) and WeightedSimilarity(n,r) when (n,r) are both small.

### G. The “Random Researcher Model” for Topical Research

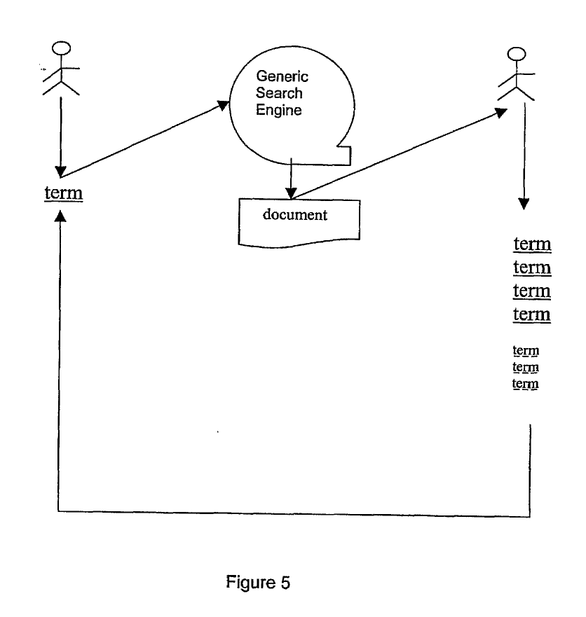

We propose a “random researcher model” that captures much of the essence of topical research. As shown in FIG. 5, a researcher conducts a topical research with the help of a generic search engine. Given a term, the engine finds all documents that contain the term and displays one document according to a probability proportional to the weight of the term in it; namely if the term has a heavy weight in a document, then the document has a high chance to be displayed.

The researcher enters the following loop: Step 1, submit a term to the generic search engine; Step 2, read the returned document and pick a term in the document according to a probability proportional to the term's weight in the document; and loop back to Step 1. During the loop a score is updated for each page and term as follows: each time the researcher reads a page a point is added to its score, and each time a term is picked by the researcher a point is added to its score.

The scores of documents and terms indicate how often each document and term is exposed to the researcher. The more exposure a document or term receives, the higher its score thus its importance. Since both the engine and the research behave according to elements in the document-term matrix, the importance of the terms and documents is entirely decided by the document-term matrix.

It should be apparent to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps could be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of facilitating a search that employs a search term, comprising:
determining variable weights for each of a plurality of document terms as a function of prevalence of the terms in a data set;
calculating document scores for a plurality of documents as a function of prevalence and weight of document terms contained therein; and
ranking each of the first and second documents as a function of (a) its corresponding document scores and (b) the closeness of the search terms and the document terms contained therein.

2. The method of claim 1, wherein the data set comprises the plurality of documents.

3. The method of claim 1, further comprising iterating the steps of determining and calculating.

4. The method of claim 1, wherein the plurality of documents includes Internet web pages.

5. The method of claim 1, wherein the plurality of documents includes journal articles.

6. The method of claim 1, further comprising using a matrix to store the weights for at least some of the document terms found within the first document.

7. The method of claim 6, further comprising using the matrix to store the weights for at least some of the document terms found within the second document.

8. The method of claim 6, further comprising computing an eigenvector of the matrix.

9. The method of claim 6, further comprising using a matrix dot product as a measure of the similarity of the matrix with a second matrix.

10. The method of claim 6, further comprising outsourcing at least one of the steps of determining, calculating, and ranking.

11. The method of claim 1, further comprising determining a first signature for a first collection containing the first and second documents, based upon their respective document scores.

12. The method of claim 11, wherein the step of ranking further comprises ranking the first and second documents along with additional documents in the first collection, based upon their respective document scores.

13. The method of claim 11, further comprising determining a second signature for a second collection containing third and fourth documents, based upon their respective document scores.

14. The method of claim 13, wherein the first and second collections are mutually exclusive.

15. The method of claim 13, further comprising using the first and second signatures to determine importance of the first and second collections relative to the search terms.

16. A method of ranking first and second collections of documents relative to a search term, comprising;
calculating a first signature for the first collection of documents and a second signature for the second collection of documents; and
calculating closeness of the first and second signatures to the search term.

17. The method of claim 16 wherein the step of calculating the first signature comprises weighting terms in the first collection using an iterative process.

18. The method of claim 16 wherein the step of calculating the first signature comprises calculating the first signature independently of the search term.

19. The method of claim 16 wherein the step of calculating the first signature comprises calculating relative importance of terms included in the first collection.
